(19) United States
(12) Patent Application Publication
(10) Pub. No.: US 2025/0224066 A1
(43) Pub. Date: Jul. 10, 2025

(54) PRESSURE BALANCING SEAL

(71) Applicant: USA Industries, LLC, Houston, TX (US)

(72) Inventors: John Rey De La Cruze DE LEON, Pearland, TX (US); Richard Sallee, Liberty, TX (US); Armando Garza, Friendswood, TX (US); Hector Davila, South Houston, TX (US)

(21) Appl. No.: 19/007,937

(22) Filed: Jan. 2, 2025

Related U.S. Application Data
(60) Provisional application No. 63/617,668, filed on Jan. 4, 2024.

(51) Int. Cl. F16L 55/132

(52) U.S. Cl. CPC F16L 55/132

(57) ABSTRACT

The embodiments disclosed herein relate to a plug for sealing against the interior surface of a pipe, the plug having a front end and a back end, and having a first compression plate; a second compression plate beneath the first compression plate; a seal ring between the first compression plate and the second compression plate; a cavity defined between the first compression plate and the second compression plate; and a fluid opening connected from the back end of the plug to the cavity.

### BACKGROUND

### Technical Field

The subject matter generally relates to the hydrostatic testing and isolating of pipe, piping systems, pressure vessels and tubing.

During hydrostatic testing and isolation, pressure is supplied at the back end of the conventional pipe plug. When the conventional pipe plug is under an expected amount of pressure, the seal of the pipe plug expands to engage and seal against the pipe wall to prevent any liquid/fluid from leaking. However, at a much higher pressure, the seal expansion tends to yield, or potentially damage, the wall of the pipe that the conventional plug is installed in. Currently, one present solution is to prevent the two compression plates from collapsing by dampening their movement with rubber pucks that are installed within the cavity of the two plates. Alternatively, some manufacturers use a much harder pipe plug seal to prevent the two compression plates from collapsing which in turn exerts less radial force on the pipe's wall; however, due to the harder seal that other manufacturers use, the torque values of such pipe plugs are much higher to achieve the initial seal against the pipe wall.

Accordingly, a need exists for an improved pipe plug which can balance the forces exerted on the seal and reduce the radial force exerted by the seal against the pipe.

### BRIEF SUMMARY

The embodiments disclosed herein relate to a plug for sealing against the interior surface of a pipe, the plug having a front end and a back end, and having a first compression plate; a second compression plate beneath the first compression plate; a seal ring between the first compression plate and the second compression plate; a cavity defined between the first compression plate and the second compression plate; and a fluid opening connected from the back end of the plug to the cavity.

The embodiments disclosed herein also relate to: a plug for sealing against the interior surface of a pipe, the plug having a front end and a back end, having: a first compression plate; and/or a second compression plate beneath the first compression plate; and/or a seal ring between the first compression plate and the second compression plate; and/or a cavity defined between the first compression plate and the second compression plate; and/or a fluid opening connected from the back end of the plug to the cavity; and/or a pipe nipple threaded to the first compression plate or any sealed connection to the first compression plate, wherein the pipe nipple or any sealed connection is hollow and/or is fluidly connected with the fluid opening and/or the cavity; and/or a plurality of shafts inserted through the first compression plate, through the cavity, and/or into or through the second compression plate; and/or a sealing mechanism between the first compression plate and each of the plurality of shafts. The plug for sealing may also optionally have an activated state of the plug wherein the seal ring engages the interior surface of the pipe, and/or an inactive state of the plug wherein the seal ring is disengaged from the interior surface of the pipe; and/or a volume of fluid applied against the back end of the plug in the activated state, wherein the volume of fluid flows within the fluid opening, the cavity, and/or the pipe nipple; and/or further wherein the volume of fluid is prevented from flowing between: an exterior surface of the seal ring and/or the interior surface of the pipe and/or each of the plurality of shafts and the first compression plate; and/or further comprising a bushing around each of the plurality of shafts, wherein each bushing is located within the first compression plate; and/or further comprising a first O-ring between each bushing and each of the plurality of shafts, and/or a second O-ring between each bushing and the first compression plate.

The embodiments disclosed herein also relate to: a method of balancing a pressure experienced by a seal ring, an O-ring seal, or any sealing mechanism in a plug for sealing against the interior of a pipe during an activated state of the plug, and having the steps of: providing a fluid against a back end of the plug within the pipe, wherein the fluid against the back end of the plug supplies a first force in a first direction against the seal ring; and/or providing the fluid within a cavity of the plug, wherein the fluid within the cavity of the plug supplies a second force in a second direction, wherein the second direction is opposite the first direction; and/or wherein the step of providing the fluid within the cavity of the plug further comprises the step of reducing the first force experienced by the seal ring; and/or wherein the seal ring is located between a first compression plate and a second compression plate of the plug and wherein an exterior surface the seal ring is adjacent to the interior of the pipe; and/or further wherein the cavity is defined between the first compression plate and the second compression plate of the plug; and/or wherein the second compression plate defines an opening which is fluidly connected to the cavity and to the back end of the plug; and/or a pipe nipple sealingly threaded to the first compression plate, and/or further comprising the step of enabling the fluid to flow into the pipe nipple and/or further comprising a plurality of shafts inserted through the first compression plate, through the cavity, and/or partially into the second compression plate; and/or further comprising the steps of preventing leakage of the fluid between the seal ring and the interior of the pipe when the plug is in the activated state, and/or preventing leakage of the fluid between the shaft and the first compression plate; and/or wherein the cavity is further defined by an elevated surface of the second compression plate, and/or a recessed surface of the first compression plate, and/or a flange about the circular circumference of the first compression plate; and/or wherein the step of providing the fluid against the back end of the plug within the pipe comprises the step of providing the fluid at a front end of the plug through the pipe nipple and/or flowing the fluid from the front end of the plug to the back end of the plug through the pipe nipple.

The embodiments disclosed herein also relate to: a plug for sealing against the interior surface of a pipe, the plug having a front end and a back end, having: a first compression plate defining a recessed surface facing the back end of the plug and/or having a flange defined around the recessed surface and extended towards the back end of the plug; and/or a second compression plate beneath the first compression plate, wherein the second compression plate comprises a base and/or an elevated surface rising from the base; and/or wherein the elevated surface defines a cylindrical wall having a smaller circumference than the base; and/or a fluid opening defined within the second compression plate, wherein the fluid opening is fluidly connected to the back end of the plug; and/or a seal ring configured to be compressible and/or located above the base of the second compression plate and/or beneath the flange of the first compression plate; and/or a cavity defined by the elevated surface of the second compression plate and/or the recessed surface of the first compression plate, and/or wherein the cavity is fluidly connected to the fluid opening; and/or wherein the cavity is further defined by the flange of the first compression plate; and/or further comprising a pipe nipple threaded into the first compression plate and/or a plurality of bolts inserted through the first compression plate and/or into the second compression plate; and/or further comprising a bushing around each of the plurality of bolts, wherein each bushing is located in the first compression plate, and/or further wherein each bushing is configured to seal against leakage of fluid.

The embodiments disclosed herein also relate to: a method of sealing a pipe with a plug having the steps of positioning the plug to a desired location within the pipe; and/or torquing a nut on each of a plurality of bolts inserted through a first clamping plate and/or into or through a second clamping plate of the plug; and/or compressing the first clamping plate and the second clamping plate together; and/or squeezing a sealing ring situated between the first clamping plate and the second clamping plate; and/or engaging an interior surface of the pipe with the sealing ring; and/or supplying a fluid to a back of the plug and/or to a cavity between the first clamping plate and the second clamping plate; and/or reducing a first force experienced by the seal ring from the back of the plug via a second force derived from the fluid within the cavity; and/or further comprising the step of preventing overexpansion of the seal ring and/or preventing yielding of the pipe.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this disclosure, and are not to be considered limiting of its scope, for the disclosure may admit to other equally effective embodiments. The figures are not necessarily to scale and certain features and certain views of the figures may be shown exaggerated in scale or in schematic in the interest of clarity and conciseness.

FIG. 1 depicts a side cross section view of an exemplary embodiment of a plug for sealing a pipe.

FIG. 2 depicts a side cross section view of an exemplary embodiment of a plug for sealing a pipe and a diagram of the fluid flow path during the pressurization process.

FIG. 3 depicts a side cross section view of an exemplary embodiment of a plug for sealing a pipe and a diagram of the forces experienced by the seal during the pressurization process.

FIG. 3A depicts an enlarged cross section side view of an exemplary embodiment of a bushing with O-rings for a bolt of the plug of FIG. 3.

FIG. 3B depicts an enlarged cross section side view of an alternative exemplary embodiment of O-rings for a bolt of the plug for sealing a pipe.

FIG. 4 depicts a side cross section view of an alternative exemplary embodiment of a plug for sealing a pipe.

FIG. 5 depicts a side cross section view of an alternative exemplary embodiment of a plug for sealing a pipe and a diagram of the fluid flow path during the pressurization process.

### DETAILED DESCRIPTION OF THE EMBODIMENT(S) SHOWN

The description that follows includes exemplary apparatus, methods, techniques, and instruction sequences that embody techniques of the inventive subject matter. However, it is understood that the described embodiments may be practiced without these specific details.

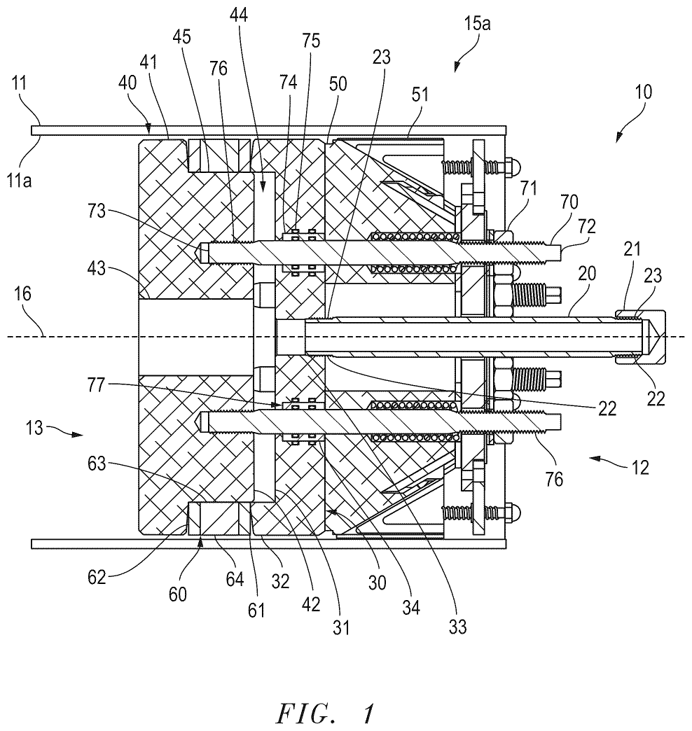

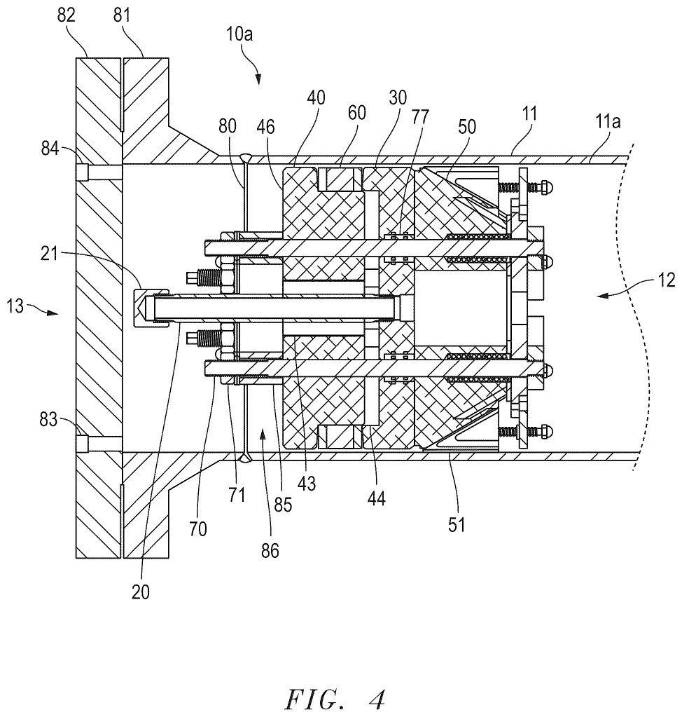

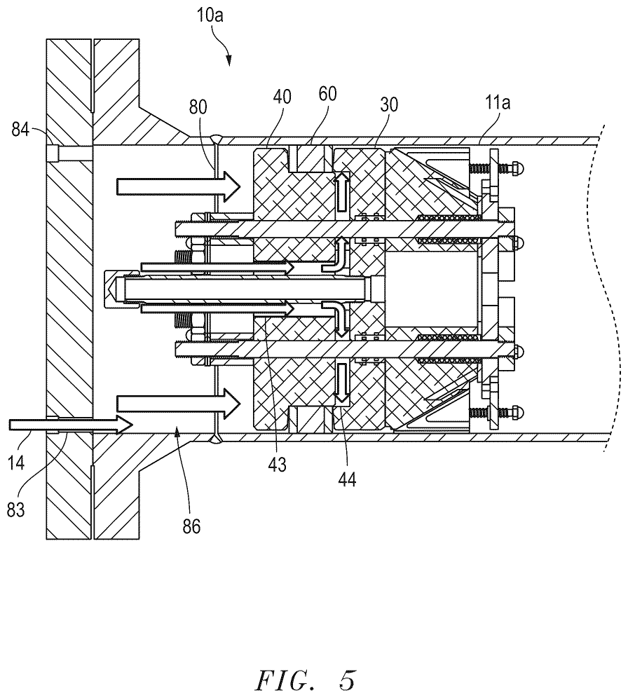

FIG. 1 depicts a side cross section view of an exemplary embodiment of a plug 10 for sealing against the interior surface 11a of a tube, vessel, or pipe 11. The plug 10 has a front side or end 12 and a rear or back side or end 13, and a longitudinal axis 16 which connects the front end 12 with the rear end 13. The plug 10 as depicted in FIGS. 1-3 can be used for outboard applications in a pipe 11; however, the plug 10 can be modified for inboard applications as is encompassed within this disclosure, and as is depicted in FIGS. 4-5. The rear side or end 13 is part of the internal area of the pipe or vessel 11. The plug 10 has at least a first or top compression or clamping plate 30, a second or bottom compression or clamping plate 40, at least one seal ring, sealing means, O-ring seal, or other sealing mechanism 60 positioned between the two compression plates 30, 40, and a tube, a hose, sealed connection, or pipe nipple 20 sealingly connected to the first compression plate 30. The plug 10 may optionally further include grippers 51 as slidably mounted on a wedge cone 50, above the top clamping plate 30.

The first or top clamping or compression plate 30 defines a recessed surface 31 facing the rear side 13 or on the bottom of the first compression plate 30, which is surrounded by a flange or extension 32 about the circular circumference of the first plate 30, wherein the flange 32 is extended towards the back end 13 of the plug 10. The first or top clamping or compression plate 30 may be constructed of a unitary, single, one-piece or plate of aluminum wherein the recessed surface 31 of a smaller diameter than the top one-piece plate 30 is machined into the top one-piece plate 30. The first plate 30 also defines a number of openings 34 for the insertion of bolts 70 through the first plate 30 and sealing mechanisms 77, optionally bushings 74, which surround the bolts 70 within the first plate 30. The center of the first plate 30 further defines a pipe nipple opening 33 which may be threaded for sealingly engaging the pipe nipple 20. The pipe nipple 20 may be a hollow tube defining threads 22 or any other connections, couplings, connection means, or coupling means 23 on both ends of the pipe nipple 20. Connections or couplings 23 on the ends of the pipe nipple 20 can include, and are not to be limited to National Pipe Thread (NPT) threaded connections, Joint Industry Council (JIC) compression fittings, quick disconnect systems without threads/treads, amongst others as known to one of ordinary skill in the art and as is encompassed by the present disclosure. At the front end 12 of the plug 10, the pipe nipple 20 may extend out of the plug 10 and be closed or sealed off with a cap or fitting 21, or further connected to another fitting 21 or hose.

The second or bottom plate 40 has a base 41 and an elevated surface 42 rising from base 41, wherein the elevated surface 42 defines a cylindrical side or wall 45 having a smaller circumference than the base 41. The elevated surface 42 and the recessed surface 31 define and are separated by a fluid chamber or cavity 44. The cavity 44 may be centered about the longitudinal axis 16 of the plug 10 or pipe 11. The elevated surface 42 and the walls 45 may complementarily fit, insert, or engage into the recessed surface 31 and the flange 32 of the top plate 30 as the plates 30, 40 compress together. Accordingly, the area of the fluid chamber or cavity 44 may decrease as the plates 30, 40 compress. The second plate 40 further includes a fluid port or opening 43 at the center of the second plate 40, defined through the base 41 and the elevated surface 42, and further which is in fluid connection, fluidly connected, or open to the fluid cavity 44 between the first compression or clamping plate 30 and the second compression or clamping plate 40. The fluid chamber or cavity 44 is capable of retaining a volume of fluid or water 14 within the area defined by the elevated surface 42, the flange 32, and the recessed surface 31. In alternative exemplary embodiments (not illustrated herein), the top plate 30 may omit the recessed surface 31 and the bottom plate 40 may omit the elevated surface 42, such that the plate 30,40 are flat plates which compress the seal 60.

A seal 60 constructed of compressible or flexible material is positioned between the two compression plates 30 and 40. The seal 60 has a ring-like shape, defining an interior surface 63 and an exterior surface 64, wherein both the interior surface 63 and exterior surface 64 are curved, cylindrical surfaces connected by a flat seal top surface 61 and a flat seal bottom surface 62. The flange 32 of the first compression plate 30 may be directly adjacent and abut the top surface 61 of the seal 60, and the base 41 of the second compression plate 40 may be directly adjacent and abut the bottom surface 62 of the seal 60. The seal's interior surface 63 may be directly adjacent to and abut the walls or sides 45 of the raised or elevated surface 42 of the second plate 40. The exterior surface 64 of the seal 60 is configured to engage and seal against the inner or interior surface 11a of the pipe 11 when the seal 60 is sufficiently compressed or activated by the first compression plate 30 and the second compression plate 40.

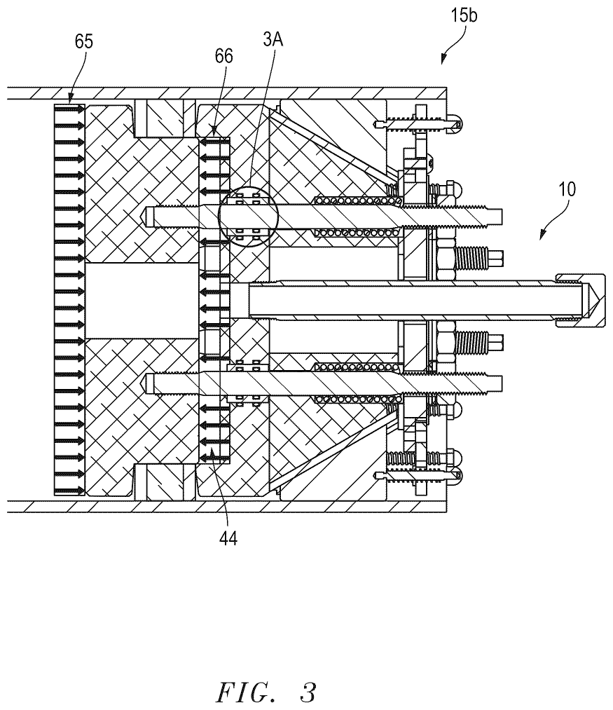

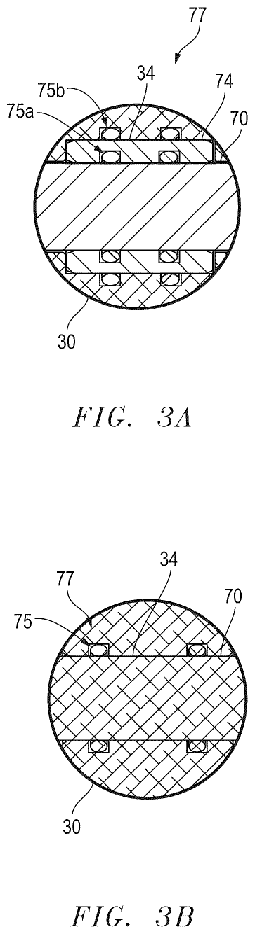

A plurality of bolts, shafts, compression shafts, or fasteners 70 are inserted through the wedge cone 50, through the first or top clamping or compression plate 30, and into the second or bottom clamping or compression plate 40. The bolts 70 may have a first end 72 towards the front 12 of the plug 10, and a second end 73 towards a rear 13 of the plug 10. Both the first end 72 and the second end 73 may define threads, wherein the second end 73 of each bolt 70 is inserted or threaded partially into the second compression plate 40 and a nut 71 is threaded onto the first end 72 of each bolt 70. In further alternative exemplary embodiments (not depicted), the bolt or shaft 70 may be also inserted through the second compression plate 40 and the second end 73 of the bolt 70 can then threaded to a nut 71 on the back end 13 of the plug 10. Within the first plate 30, each bolt 70 is surrounded by a sealing mechanism 77, which optionally includes a bushing 74, the enlarged details of which are depicted in FIG. 3A. Each optional bushing 74 in FIG. 3A includes O-ring seals 75 both on the interior and exterior of the bushing 74 to prevent leakage of fluid between or past the first compression plate 30 and the shafts 70; by way of example only, each bushing 74 may contain two O-ring seals 75a between the interior surface of the bushing 74 and the bolt 70, and may further contain two O-ring seals 75b between the exterior surface of the bushing 74 and the hole or opening 34 of the first compression plate 30. FIG. 3B depicts an alternative exemplary embodiment of a sealing mechanism 77 between the bolts or shafts 70 and the first plate 30. As shown in FIG. 3B, the bushing 74 may be omitted and one or more O-ring seals 75 can be used directly between the opening or hole 34 of the first plate 30 and the bolt 70 to prevent leakage of fluid or liquid 14; by way of example only, each bolt 70 may contain two O-ring seals 75 between the bolt 70 and the first plate 30. Any number or combination of O-ring seals 75, 75a, and 75b are considered within the scope of the disclosure, so long as the O-ring seals 75 whether in or not in combination of a bushing 74 seals against the flow of fluid, gas, or water or other medium 14 through the first or top compression or clamping plate 30. For those alternative exemplary embodiments where the shaft or bolt 70 goes through the second compression plate 40, O-ring seals 75 may also be provided around the shaft or bolt 70 and between the second compression plate 40. Other types of sealing mechanisms 77 as known to one of ordinary skill in the art, beyond combinations of O-rings 75, 75a, 75b and/or bushings 74 are considered within the scope of the disclosure, such as and not to be limited to: packing, lip seals, mechanical seals, double seals, tandem seals, cartridge seals, and/or gas barrier seals.

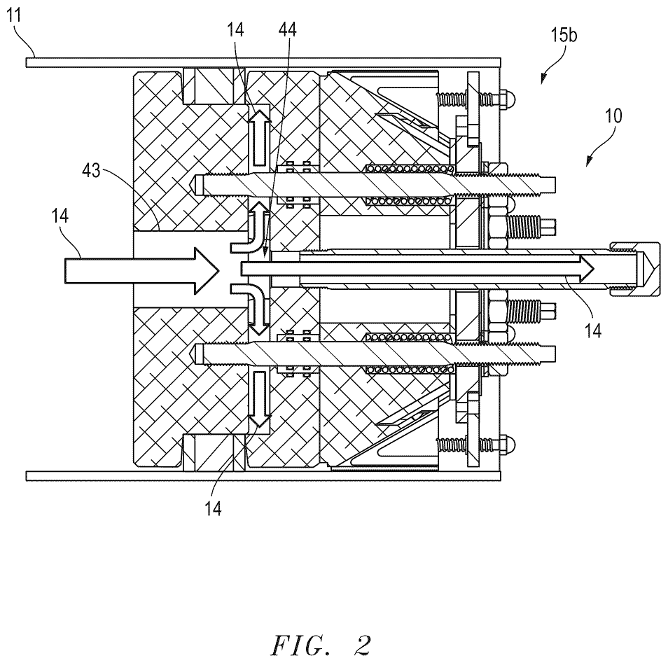

FIG. 2 depicts a side cross section view of an exemplary embodiment of a plug 10 for sealing a pipe 11 and a diagram of the fluid or water 14 flow path during pressurization for a hydrostatic test or pipe isolation process, and wherein the plug 10 is in an activated state 15b. During a hydrostatic or isolation operation, procedure, or process, the seal 60 of the plug 10 seals and engages the interior surface 11a of the pipe 11 in an activated state 15b of the plug 10, switching from an inactive state 15a, wherein the seal 60 does not engage or seal against the interior surface 11a of the pipe 11 (compare, by way of example FIG. 1 which shows an inactive state 15a, with the active states 15b depicted in FIGS. 2-3). After the seal 60 seals against the pipe 11, pressure is applied via fluid 14 to the back or rear end 13 of the plug 10. The fluid 14 flows into the fluid cavity 44 via the fluid port/opening 43 and may also flow into the hollow of the pipe nipple 20, as the pipe nipple 20 is fluidly connected to both the fluid port/opening 43 and the fluid cavity 44. The fluid 14 entering into the fluid cavity or chamber 44 balances the pressures or forces 65, 66 experienced by the seal 60 and aids in preventing the yielding of the pipe 11. If the plug 10 is in the inactive state 15a, fluid or water 14 will not fill the cavity 44 and instead will flow or leak past the unengaged seal 60 and interior surface 11a of the pipe 11.

FIG. 3 depicts a side cross section view of an exemplary embodiment of a plug 10 for sealing a pipe 11 and a diagram of the forces 65, 66 experienced by the seal 60 during the pressurization process while the plug 10 is in an active state 15b. The first force 65 as depicted is the force vector from the fluid 14 pressure from the back end 13 of the plug 10, as fully exerted on the seal 60 of the plug 10. However, the seal 60 of the plug 10 only experiences a fraction of first force 65 due to the second force vector 66 from the fluid 14 pressure, entering into the cavity 44 between the two compression plates 30, 40 through the fluid port/opening 43 of the second plate 40. Note that there is an equal and opposite force going against force 66 inside cavity 44 that is excreted on the recessed face 31 of first compression plate 30 that is not depicted in the illustration of FIG. 3. The force excreted against recessed face 31 is not shown since the described force against the recessed face 31 does not play role in the balancing of the forces 65, 66 on the plug's seal 60. With the improved pressure balancing seal 10, the second force or force vector 66 is subtracted from the first force or force vector 65 and only a part or fraction of the first force 65 squeezes, clamps, or compresses the seal 60 of the plug 10 which prevents the seal 60 from over-expanding and yielding the wall of the pipe 11 which can often occur in conventional or current plugs available in the market. In conventional plugs, the seal experiences the full extent of the force from the back end of the plug, and thus the seal commonly experiences overexpansion and may yield or damage the wall of the pipe. In the improved plug 10 with the pressure-balancing seal 60, the cavity 44 between the compression plates 30, 40 has the same fluid 14 supplied from the back 13 of the plug 10. The O-ring seals 75 prevent the fluid 14 pressure from leaking through the shaft or bolt 70 and/or in combination with a bushing 74. The pipe nipple 20 is threaded into and seals the top compression plate 30 that lets the fluid 14 pressure enter the cavity 44 between the two compression plates 30, 40.

For a hydrostatic test or pipe isolation operation, the plug 10 is positioned by an operator, said plug 10 being in an inactive state 15a, to a desired location within the pipe 11. The grippers 51 may be actuated by springs and may slide along the wedge cone 50 to aid in positioning the plug 10, and preventing the plug 10 from accidental ejection from the pipe 11. When the plug 10 is at the desired location, the nuts 71 are actuated, tightened or torqued along the bolts 70 to squeeze the seal 60 via compressing or moving both the first plate 30 and the second plate 40. Once the exterior surface 64 of the seal 60 initially engages or touches the interior surface 11a of the pipe 11, the seal 60 will become stationary within the pipe 11; however, the nuts 71 can still be further actuated, torqued or tightened thus further compressing the plates 30, 40 closer together to achieve a greater sealing or engagement of the seal 60 against the interior surface 11a of the pipe 11. The activated state 15b of the plug 10 occurs as a result of the engagement of the seal 60 against the interior surface 11a of the pipe 11.

Once the plug 10 and the seal 60 are in the activated state 15b, fluid or water 14 can be supplied via the rear or back end 13 of the plug 10, or from the front end 12 of the plug 10 though the pipe nipple 20 using the front connection 23 with the top plate 30. The fluid 14 enters into the fluid port/opening 43 of the second plate 40 (when supplying fluid 14 from the back end 13) or through the pipe nipple 20 (when supplying fluid from the front end 12) and fills the fluid cavity 44. When supplying fluid 14 from the back end 13, the fluid 14 may also optionally enter into the pipe nipple 20 as capped by the fitting 21. However the fluid 14 is prevented from flowing or leaking between the bolt 70 and the first plate 30 through either: the bushing 75 and O-rings 75a, 75b (O-rings 75a prevent leaking between the optional bushing 74 and the bolt 70, whereas O-rings 75b prevent leaking between the optional bushing 74 and the first plate 30); or O-rings 75 without the bushing 74 (in this latter alternative exemplary embodiment, O-rings 75 prevent leaking between the first plate 30 and the bolts 70). The fluid 14 is also prevented from flowing past or between the seal 60 and the pipe interior surface 11a in the activated state 15b. As described earlier, the first force vector 65 from the fluid 14 pressure is exerted against the seal 60 from the rear or back end 13 of the plug 10; however the first force vector 65 is balanced, or reduced from the second force vector 66 from the fluid 14 pressure exerted against the seal 60, wherein the second force 66 is in a vector direction opposite the first force vector 65, and within the fluid cavity 44. Accordingly, the pressures or forces 65, 66 are balanced for the seal 60 and reduces the risk of overexpanding the seal 60 and causing the pipe 11 to yield or become damaged. When supplying fluid 14 from the front end 12 through the pipe nipple 20, the pipe nipple 20 can be recapped with the fitting 21 when the seal 60 is balanced with the forces 65, 66, and/or when all of the air is removed or purged from the plug 10 and pipe 11. In certain instances, the fitting 21 may be capped over the pipe nipple 20 immediately after filling with fluid 14 if no air is needed to be purged (such as when nitrogen is used as the medium 14).

When the hydrotest or isolation process is complete and the plug 10 is ready for removal from the pipe 11, the supply of fluid 14 may be stopped, drained and the pressure relieved from the pipe 11. The nuts 71 are untorqued and/or rotated in an opposite direction on the bolts or shafts 70. The compression on the plates 30, 40 is relieved and the exterior surface 64 of the seal ring 60 releases or disengages from the interior 11a of the pipe 11. The grippers 51 proceed to disengage from the interior 11a when the nuts 71 are loosed or loosened and back up all the way on top end 72 of the shaft 72 and the plug 10 can be safely removed from the pipe 11.

FIG. 4 depicts a side cross section view of an alternative exemplary embodiment of a plug 10a, or inboard plug 10a, for sealing the interior or inner surface 11a of a pipe, tube, or vessel 11. The alternative exemplary embodiment of plug 10a may be used for inboard applications, such as testing a weld 80, wherein the weld 80 may be the joining or connection between a weld flange or welding neck flange 81 and a pipe 11. Like the exemplary embodiment of plug 10, the plug 10a also has a front side or end 12 and a rear or back side or end 13, a first or top compression or clamping plate 30, a second or bottom compression or clamping plate 40, a fluid chamber 44 between the first plate 30 and the second plate 40, at least one seal ring, sealing means, O-ring seal, or other sealing mechanism 60 positioned between the two compression plates 30, 40, and a tube, a hose, sealed connection, or pipe nipple 20 sealingly connected to the first compression plate 30. The pipe nipple 20 of plug 10a extends from the central axis 16 of the rear end 13 of the plug 10a, or the bottom/rear surface 46 of the second plate 40, and is capped with cap or fitting 21 at the rear 13 of the pipe nipple 20. The pipe nipple 20 may be inserted through the fluid port 43, without preventing or plugging the flow of fluid 14 into the fluid chamber 44 defined between the first plate 30 and the second plate 40.

In the alternative exemplary embodiment of the plug 10a, the bolts, shafts, compression shafts, or fasteners 70 are inserted through the second plate 40, through the first plate 30, and through the wedge cone 50; a portion, section or segment of the bolts 70 also extend from the rear end 13 of the plug 10a, or the bottom/rear surface 46 of the second plate 40. It is noted that, unlike the exemplary embodiments of the plug 10 as depicted in the FIGS. 1-3, the bolts 70 go through the second plate 40 instead of being inserted partially into the second plate 40 (although in certain alternative exemplary embodiments of the outboard plug 10, the bolts 70 may also go through the body of the second plate 40). The bolts 70 each include a nut 71 which are mounted on the bolts 70 towards the rear 13 of the plug 10a. The bolts 70 may further include a compression tube or spacer 85 between the nut 71 and the bottom surface 46 of the second plate 40. The bolts or shafts 70 are tightened or rotated from the rear end 13, which may also be referred to as “reverse” style of tightening or actuating.

When testing the sufficiency of the weld 80, a blind flange 84 is installed, connected, or mounted onto the welding neck flange 81. An area or chamber 86 may be defined by the interior surface 11a of pipe 11, the weld neck flange 81, and the bottom surface 46 of the second plate 40. The blind flange 84 may include a gasket, and define a fill or filling port 83 in fluid connection with the area 86 for transporting fluid 14 into same. The blind flange 84 may also define a venting port 84 in fluid connection with the area 86 for removing or bleeding air from the area 86.

FIG. 5 depicts a side cross section view of an alternative exemplary embodiment of a plug 10a for sealing a pipe 11 and a diagram of the fluid 14 flow path during the pressurization process. As can be seen in FIG. 5, the fluid 14 enters from the filling port 83 into the area 86 that is defined by the weld flange 81, the second plate 40, and the pipe 11, and proceeds to flow past the bolts 70 into the fluid port 43 defined in the bottom or second compression plate 40. The fluid 14 continues to flow into the fluid chamber or cavity 44 defined between the second plate 40 and the first plate 30. Due to the sealing mechanisms or devices 77 between the bolts 70 and the first plate 30 and the seal 60 against the pipe interior surface 11a, the fluid 14 does not leak or go pass the first plate 30 and the bolts 70.

Referring to FIGS. 4-5, when the weld 80 is ready to be tested, the plug 10a is inserted into the pipe 11 with the front end 12 entering first, in a reverse style unlike the outboard embodiment of the plug 10. Once the plug 10a is in the desired location, the nuts 71 are tightened or torqued along the bolts or shafts 70, at the rear 13 of the plug 10a, to expand both the seal 60 and actuate the grippers 51. The cap 21 is usually installed on the pipe nipple 20 before the plug 10a is inserted into the pipe 11. Once the seal 60 is expanded and the nuts 71 are tightened to the desired torque, the next step is to install the blind flange 82 to the welding neck flange 81. The blind flange 82 may include a gasket and may, in exemplary embodiments, be connected to the welding neck flange 81 with bolts and nuts (not illustrated). There is no need to do any air purging in this alternative exemplary embodiment reverse-style plug 10a, the blind flange 82 takes care of air removal via bleeding through the venting port 84. Once the nuts 71 are torqued to the desired specification, water/fluid 14 can be introduced to the fill port 83 while keeping the venting port 84 open to remove air, or allow air to escape, from the area 86 or the pipe 11, welding neck flange 81, and plug 10a system. The water/fluid 14 will flow into the opening 43 of the second plate 40 just like in the exemplary embodiment of the outboard plug 10 and fill the cavity 44 between plates 30 and 40, and thus enabling the pressure balancing of the forces 65,66 for the seal 60 also as described above for the plug 10. Once the area 86 as defined between the plug 10a, the pipe 11, and the welding neck flange 81 is filled with water/fluid 14, the venting port 84 can be plugged, capped, or otherwise secured and pressure can be introduced to test the weld or weld connection 80. Once the hydro or pressure test is complete, the fluid or water 14 can be drained from the fill port 83. The blind flange 82 and gasket can be removed, and the nuts 71 can be loosened or untorqued to relax the seal 60. The plug 10a can now be removed from the pipe 11 and welding neck flange 81.

While the exemplary embodiments are described with reference to various implementations and exploitations, it will be understood that these exemplary embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A plug for sealing against the interior surface of a pipe, the plug having a front end and a back end, comprising:
a first compression plate;
a second compression plate beneath the first compression plate;
a seal ring between the first compression plate and the second compression plate;
a cavity defined between the first compression plate and the second compression plate; and
a fluid opening connected from the back end of the plug to the cavity.

2. The apparatus according to claim 1, further comprising a pipe nipple threaded to the first compression plate or any sealed connection to the first compression plate, wherein the pipe nipple or any sealed connection is hollow and is fluidly connected with the fluid opening and the cavity.

3. The apparatus of claim 2, further comprising a plurality of shafts inserted through the first compression plate, through the cavity, and into or through the second compression plate.

4. The apparatus of claim 3 comprising of a sealing mechanism between the first compression plate and each of the plurality of shafts.

5. The apparatus according to claim 4, further comprising an activated state of the plug wherein the seal ring engages the interior surface of the pipe, and an inactive state of the plug wherein the seal ring is disengaged from the interior surface of the pipe.

6. The apparatus according to claim 5, further comprising a volume of fluid applied against the back end of the plug in the activated state, wherein the volume of fluid flows within the fluid opening, the cavity, and the pipe nipple; and further wherein the volume of fluid is prevented from flowing between: an exterior surface of the seal ring and the interior surface of the pipe; and each of the plurality of shafts and the first compression plate.

7. The apparatus of claim 3, further comprising a bushing around each of the plurality of shafts, wherein each bushing is located within the first compression plate.

8. The apparatus according to claim 7, further comprising a first O-ring between each bushing and each of the plurality of shafts, and a second O-ring between each bushing and the first compression plate.

9. A method of balancing a pressure experienced by a seal ring, an O-ring seal, or any sealing mechanism in a plug for sealing against the interior of a pipe during an activated state of the plug, and comprising the steps of:
providing a fluid against a back end of the plug within the pipe, wherein the fluid against the back end of the plug supplies a first force in a first direction against the seal ring; and
providing the fluid within a cavity of the plug, wherein the fluid within the cavity of the plug supplies a second force in a second direction, wherein the second direction is opposite the first direction.

10. The method according to claim 9, wherein the step of providing the fluid within the cavity of the plug further comprises the step of reducing the first force experienced by the seal ring.

11. The method according to claim 10, wherein the seal ring is located between a first compression plate and a second compression plate of the plug and wherein an exterior surface the seal ring is adjacent to the interior of the pipe; and further wherein the cavity is defined between the first compression plate and the second compression plate of the plug.

12. The method according to claim 11, wherein the second compression plate defines an opening which is fluidly connected to the cavity and to the back end of the plug.

13. The method according to claim 12, further comprising a pipe nipple sealingly threaded to the first compression plate, and further comprising the step of enabling the fluid to flow into the pipe nipple.

14. The method according to claim 13, further comprising a plurality of shafts inserted through the first compression plate, through the cavity, and partially into the second compression plate.

15. The method according to claim 14, further comprising the steps of preventing leakage of the fluid between the seal ring and the interior of the pipe when the plug is in the activated state, and preventing leakage of the fluid between the shaft and the first compression plate.

16. The method according to claim 15, wherein the cavity is further defined by an elevated surface of the second compression plate, and a recessed surface of the first compression plate, and a flange about the circular circumference of the first compression plate.

17. The method according to claim 13, wherein the step of providing the fluid against the back end of the plug within the pipe comprises the step of providing the fluid at a front end of the plug through the pipe nipple and flowing the fluid from the front end of the plug to the back end of the plug through the pipe nipple.

18. A plug for sealing against the interior surface of a pipe, the plug having a front end and a back end, comprising:
a first compression plate defining a recessed surface facing the back end of the plug and having a flange defined around the recessed surface and extended towards the back end of the plug;
a second compression plate beneath the first compression plate, wherein the second compression plate comprises a base and an elevated surface rising from the base; and wherein the elevated surface defines a cylindrical wall having a smaller circumference than the base;
a fluid opening defined within the second compression plate, wherein the fluid opening is fluidly connected to the back end of the plug;
a seal ring configured to be compressible and located above the base of the second compression plate and beneath the flange of the first compression plate;
a cavity defined by the elevated surface of the second compression plate and the recessed surface of the first compression plate, and wherein the cavity is fluidly connected to the fluid opening.

19. The apparatus according to claim 18, wherein the cavity is further defined by the flange of the first compression plate.

20. The apparatus according to claim 19, further comprising a pipe nipple threaded into the first compression plate and a plurality of bolts inserted through the first compression plate and into the second compression plate.

21. The apparatus according to claim 20, further comprising a bushing around each of the plurality of bolts, wherein each bushing is located in the first compression plate, and further wherein each bushing is configured to seal against leakage of fluid.

22. A method of sealing a pipe with a plug comprising the steps of
positioning the plug to a desired location within the pipe;
torquing a nut on each of a plurality of bolts inserted through a first clamping plate and into a second clamping plate of the plug;
compressing the first clamping plate and the second clamping plate together;
squeezing a sealing ring situated between the first clamping plate and the second clamping plate;
engaging an interior surface of the pipe with the sealing ring;
supplying a fluid to a back of the plug and to a cavity between the first clamping plate and the second clamping plate; and
reducing a first force experienced by the seal ring from the back of the plug via a second force derived from the fluid within the cavity.

23. The method of claim 22, further comprising the step of preventing overexpansion of the seal ring and preventing yielding of the pipe.
